(19) United States
(12) Patent Application Publication
(10) Pub. No.: US 2014/0378205 A1
(43) Pub. Date: Dec. 25, 2014

(54) GAME MACHINE & METHOD FOR PRESENTING PAYOUTS

(71) Applicant: Atlas Gaming Technologies Pty. Ltd., Port Melbourne (AU)

(72) Inventors: Daniel Julio Montenegro, Port Melbourne (AU); Zenja Solaja, Port Melbourne (AU); Robert Sloot, Port Melbourne (AU); Alessandro Ciampoli, Port Melbourne (AU); Boris Mitleman, Port Melbourne (AU); Wade Clark, Port Melbourne (AU)

(73) Assignee: Atlas Gaming Technologies Pty. Ltd., Port Melbourne (AU)

(21) Appl. No.: 14/260,364

(22) Filed: Apr. 24, 2014

(30) Foreign Application Priority Data
Apr. 24, 2013 (AU) AU2013901437

(51) Int. Cl. G07F 17/32

(52) U.S. Cl. CPC G07F 17/3213; G07F 17/3244
USPC 463/20

(57) ABSTRACT

A gaming machine has a display to display images; a user interface to receive input from a player; a memory; a game controller configured to access the memory, control display of the images and process input received via the user interface. The game controller may control generation and display of a game of chance comprising a first inner wheel and at least a second concentric wheel. Each of the first inner wheel and the at least second concentric wheel comprising a plurality of segments having associated indicia, wherein the first inner wheel has fewer segments than the at least second concentric wheel or a subsequent concentric wheel. The game controller has random selection means including means for initiating simultaneous and independent rotation of each wheel; and (iii) control cessation of rotation of each of the wheels.

### CROSS-REFERENCE TO RELATED APPLICATIONS

The present application claims priority from Australian Provisional Patent Application No 2013901437 filed on 24 Apr. 2013, the content of which is incorporated herein by reference.

### TECHNICAL FIELD

Described embodiments relate generally to gaming machines and methods of controlling such machines for the presentation of payouts in gaming activities.

### BACKGROUND

Spinning wheels are commonly used to determine a prize outcome in gaming machines and television game shows. Generally, to allow for a large prize outcome, the odds of winning the prize should be quite small. This is usually achieved by either making a sector with the jackpot prize very small, or by spinning the wheel several times and requiring certain outcomes in each spin.

Some games control the jackpot odds by using “loaded wheels”, where odds of stopping at a particular segment are not equal. This is unfair to the player, and is illegal in some jurisdictions.

A very popular slot machine incorporating spinning wheels is called the “Wheel of Fortune”™. The Wheel of Fortune™ has three rotating reels for displaying symbols in a main game and, upon the reels displaying a certain combination of symbols, a large wheel spins. The large wheel has printed on it various payout awards, and the wheel randomly stops at a certain position to award the player the payout for that wheel position.

In an incarnation of Wheel of Fortune™, a progressive prize is awarded based on the total score accumulated as a result of two spins of the same wheel. This methodology allows controlling the odds of winning major jackpots, but the outcome of the play is protracted.

US Patent 20030195034 describes use of concentric wheels. The feature game spins the wheels in sequence, starting from the outer wheel. Some sectors on the wheels have arrows pointing inwards. If the currently spinning wheel stops on an arrow, the feature progresses to the next stage, and the next wheel towards the centre is spun. It takes as many spins to win a progressive prize as the number of the concentric wheels.

To increase player enjoyment and excitement, therefore, it is desirable to provide new bonus games having award wheels that provide larger awards to players with relatively low odds.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A gaming machine is provided comprising:
a display to display images;
a user interface to receive input from a player;
a memory;
a game controller configured to access the memory, control display of the images and process input received via the user interface, the game controller further configured to:
control generation and display of a game of chance comprising a first inner wheel and at least a second concentric wheel; each of the first inner wheel and the at least second concentric wheel comprising a plurality of segments having associated indicia, wherein the first inner wheel has fewer segments than the at least second concentric wheel or a subsequent concentric wheel; and
random selection means including means for initiating simultaneous and independent rotation of each wheel;
wherein the game controller is further configured to control cessation of rotation of each of the wheels, to identify at least one first segment from the first inner wheel and at least one segment from the second or a subsequent concentric wheel to determine if the combination of the identified segments comprises a winning combination.

In one embodiment the gaming machine comprises a first inner wheel and a second outer wheel wherein the first inner wheel has n segments and the second outer wheel has 2×n segments.

In a further embodiment the gaming machine comprises a first inner wheel having n segments, a second wheel having 2×n segments and a third outer wheel having 4×n segments. In other embodiments having x wheels, where x is equal to or greater than 4, the number of segments for each successive wheel is 2^{m-1}×n) where m is the wheel number.

The game controller may be further configured to control generation and display of a wheel segment selector which points to 2^{m-1} segments from each wheel when the wheels are stationary. If the combination of indicia (or symbols) from the segments which the segment selector points to equals a winning combination, the gaming machine is arranged to indicate an award to the player. The indication of an award to the player may be by way of an output.

In an embodiment, at least certain of the indicia on the first inner wheel and the second wheel comprise special symbols. A further certain of the indicia on the first inner wheel may comprise prize multipliers and a further certain of the indicia on the second wheel may comprise bonus prizes. In some cases, there may be no indicia in a particular location. In other words a blank or null space or a symbol indicative of a blank space, that has no impact on the resulting payout.

The game of chance may be a primary gaming activity though more preferably a secondary activity such as a bonus feature game.

The plurality of indicia may be positioned on the peripherals of the viewable surface face of each wheel such that all indicia on each wheel are viewable to the user.

In an embodiment, the wheels may all spin in the same direction. In another embodiment any one or more of the wheels may spin in an opposite direction of the other wheels. Each of the wheels may be rotatable about a common axis through the face of each of the wheels. Each of the wheels may spin independently from each of the other wheels. Additionally, or optionally, the speed of rotation of each wheel may be independent.

Some embodiments relate to a gaming system comprising at least one gaming machine as described above and at least one server system in communication with the game controller of the at least one gaming machine.

Some embodiments relate to a method of game play executed by a computerised game controller, the method comprising:
controlling generation and display of a game of chance comprising a first inner wheel and at least a second concentric wheel; each of the first inner wheel and the at least second concentric wheel comprising a plurality of segments having associated indicia, wherein the first inner wheel has fewer segments that the at least second concentric wheel or a subsequent concentric wheel;
initiating simultaneous and independent rotation of each wheel;
controlling cessation of rotation of each of the wheels and to register an outcome; and
identifying at least one first segment from the first inner wheel and identifying at least one segment from the second or a subsequent wheel; and
determining if the combination of the identified segments comprises a winning combination.

According to the method, the game controller may be configured to control generation and display a game of chance comprising a first inner wheel and a second outer wheel wherein the first inner wheel has n segments and the second outer wheel has 2×n segments. Optionally, the game controller is configured to control generation and display a game of chance comprising a first inner wheel having n segments, a second wheel having 2×n segments and a third outer wheel having 4×n segments.

According to the method, the game controller may be configured to control generation and display of a wheel segment selector which points to 2^{m-1} segments from each wheel when the wheels are stationary. If the combination of indicia (or symbols) from the segments which the segment selector points to equals a winning combination, the gaming machine may be arranged to indicate an award to the player.

The game of chance may be a primary gaming activity though more preferably a secondary activity such as a bonus feature game.

According to the method, the game controller may be configured to position the plurality of indicia on the peripherals of the viewable surface face of each wheel such that all indicia on each wheel are viewable to the user.

According to the method, the game controller may be configured to spin each of the wheels in the same direction. In another embodiment the game controller may be configured to spin one or more of the wheels in a first direction and the remaining wheels in an opposite direction. The game controller may be configured such that each of the wheels spin independently from each of the other wheels. Additionally, or optionally, the game controller may be configured such that the speed of rotation of each wheel is independent.

Some embodiments relate to a gaming system comprising at least one server and at least one client device, wherein the at least one server and at least one client device are configured to cooperate with each other to execute program instructions to:
control generation and display of a game of chance comprising a first inner wheel and at least a second concentric wheel; each of the first inner wheel and the at least second concentric wheel comprising a plurality of segments having associated indicia, wherein the first inner wheel has fewer segments that the at least second concentric wheel or a subsequent concentric wheel;
initiate simultaneous and independent rotation of each wheel;
control cessation of rotation of each of the wheels and to register an outcome;
identify at least one first segment from the first inner wheel and identifying at least one segment from the second or a subsequent wheel; and
determine if the combination of the identified segments comprises a winning combination.

Some embodiments relate to computer-readable storage storing executable program code that, when executed by a game controller, causes the game controller to perform the methods described above and/or implement the features and functions of the game machine or game system described above.

The computer-readable storage may, when executed by a game controller, cause the game controller to control generation and display a game of chance comprising a first inner wheel and a second outer wheel wherein the first inner wheel has n segments and the second outer wheel has 2×n segments. Optionally, the computer-readable storage may, when executed by a game controller, cause the game controller to control generation and display a game of chance comprising a first inner wheel having n segments, a second wheel having 2×n segments and a third outer wheel having 4×n segments.

The game of chance may be a primary gaming activity though more preferably a secondary activity such as a bonus feature game.

The computer-readable storage may, when executed by a game controller, cause the game controller to position the plurality of indicia on the peripherals of the viewable surface face of each wheel such that all indicia on each wheel are viewable to the user.

The computer-readable storage may, when executed by a game controller, cause the game controller to spin each of the wheels in the same direction. In another embodiment the computer-readable storage may, when executed by a game controller, cause the game controller to spin one or more of the wheels in a first direction and the remaining wheels in an opposite direction. The computer-readable storage may, when executed by a game controller, cause the game controller to spin independently from each of the other wheels. Additionally, or optionally, the game controller may be configured such that the speed of rotation of each wheel is independent.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

In order that the present invention may be more clearly ascertained, embodiments will now be described, by way of example, with reference to the accompanying drawing, in which:

FIG. 1 shows a perspective view of a gaming machine;

FIG. 2 shows a block diagram of a game logic circuit of the gaming machine illustrated in FIG. 1;

FIG. 3 shows a block diagram of functional components of a gaming system incorporating gaming machines illustrated in FIG. 1;

FIG. 4 shows an example gaming machine display illustrating the presentation screen of the bonus game before play of the bonus game; and

FIG. 5 shows an example gaming machine display illustrating the wheel spin outcome area which has resulted from the bonus game having been played.

### DESCRIPTION OF EMBODIMENTS

Described embodiments generally relate to a gaming machines and methods of controlling such machines for the presentation of payouts in gaming activities.

The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on. Other variations will be apparent to persons skilled in the art.

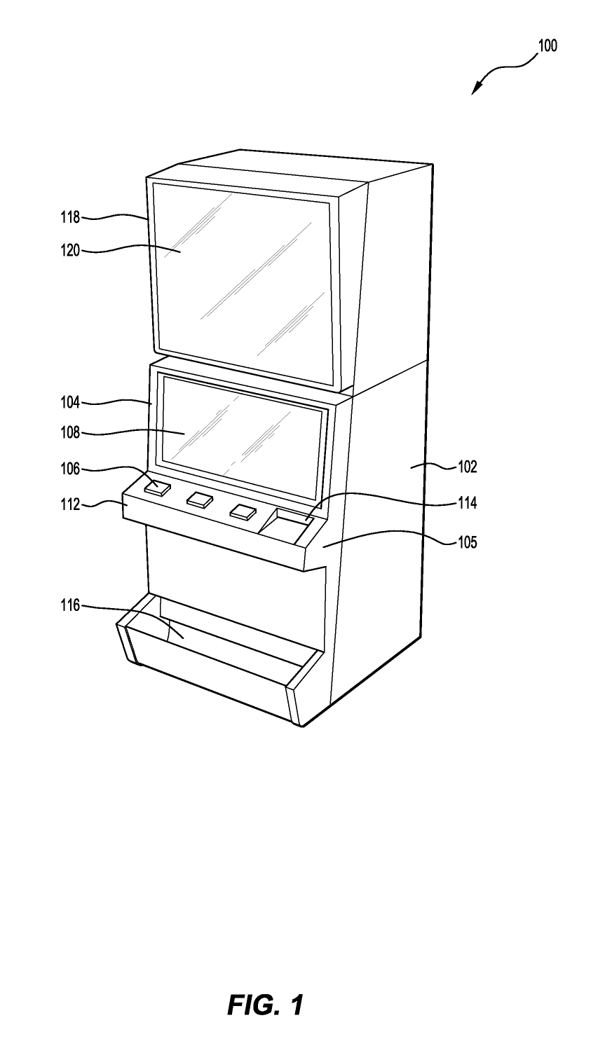

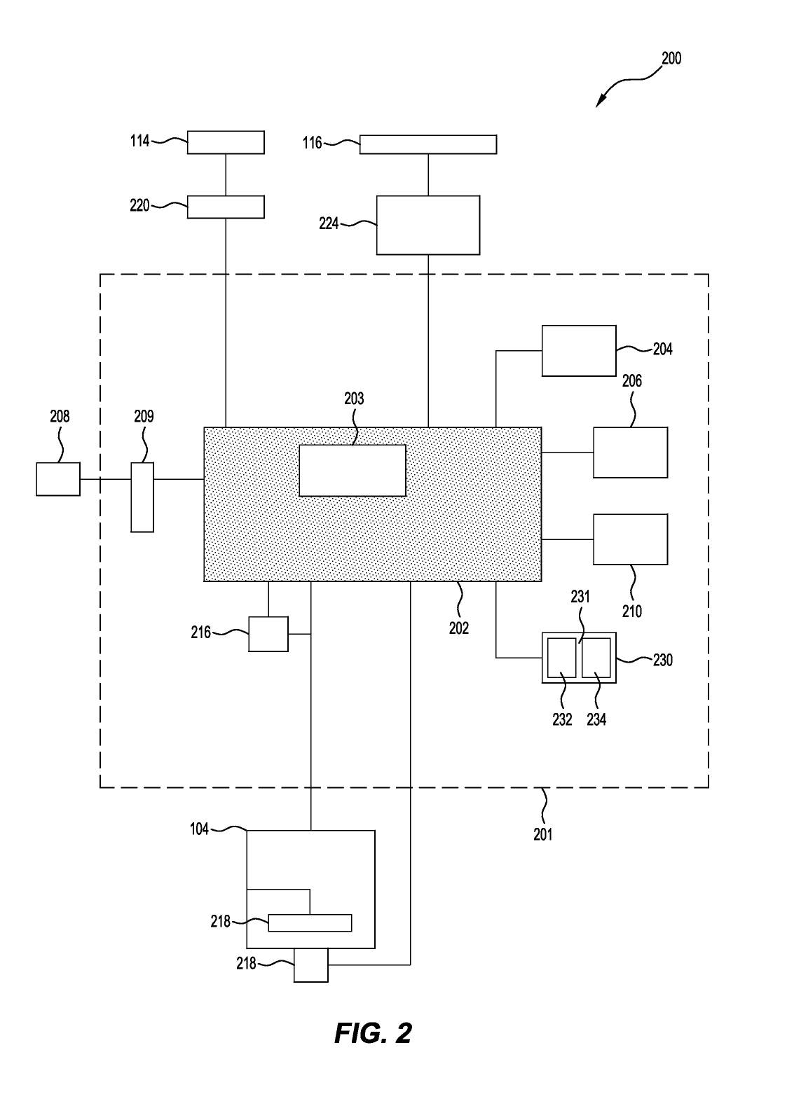

In another form, the gaming system may comprise a gaming server (or multiple gaming servers) interacting with client computing devices over a wired and/or wireless network to allow performance of the games on the client devices. Such client devices may include desktop computers, tablet computers, laptop computer and handheld computing devices (including smart phones), for example, each of which includes at least one processor and memory to store executable instructions for performing the game-related functions described herein. Such systems may therefore not require specific dedicated physical gaming machines as described herein in relation to FIGS. 1 and 2, since the client devices can in such systems perform some of the gaming functions as described herein. In such gaming systems, the client devices may locally execute gaming applications that communicate with the gaming server and, in combination with the gaming server, provide a user interface and gaming experience generally similar to that of a physical gaming machine. Thus, embodiments described herein in relation to gaming machines may be implemented “on-line” using such a client-server architecture, unless such implementations would not be physically or technologically feasible. Additionally, some embodiments described herein in relation to gaming machines may be implemented in a personal computing device without requiring interaction with a server, in which case such computing devices can be termed “gaming machines”.

One or more of the method steps described in this disclosure may be implemented by executable instructions and parameters 232, 234 (See FIG. 2), stored in the memory 204, 206, 230 (See FIG. 2), that may form software embodiments of the system 100. These instructions 232, 234 that form the system 100 may be executed by the CPU 202 (See FIG. 2) or any other processor. Further, the processor 202, the memory 204, 206, 230, the instructions 232, 234 stored therein, or a combination thereof may serve as a means for performing one or more of the method steps described herein.

Irrespective of the form, the gaming system 100 has several core components. At the broadest level, the core components are a player interface in the form of a touch screen 108 as illustrated in FIG. 1 and a game controller 200 as illustrated in FIG. 2. The player interface is arranged to enable manual interaction between a player and the gaming system and for this purpose includes the input/output components required for the player to enter instructions and play the game.

Referring now to FIG. 1, reference numeral 100 generally designates a stand-alone gaming system including a game. Hereinafter, the stand-alone gaming system 100 will be referred to as a gaming machine.

The gaming machine 100 includes a console 102 which contains all or most components required to implement a game play whereby a player wins or loses a wager. Access to the components is by way of a hinged door 105. Moulded to the exterior of the console 102 is a display means in the form of at least one visual display unit 104 on which one or more games is played. The video display unit 104 may be implemented as a liquid crystal display, a plasma screen, as a cathode ray screen device or the like. Whilst the console 102 illustrated in FIG. 1 shows a single visual display unit 104, there can be more than one visual display unit on a typical machine. What is displayed on the visual display unit 104 will depend on what the intended goal of the unit is in relation to the player and any other potential participants in the gaming system.

The gaming machine includes a tactile input for a player to interact via touch with the gaming machine 100. In this example, the tactile input is in the form of a combination of pushbuttons 106 and a touch screen 108 for enabling a player to play one or more games. The touch screen is an electronic visual display that can detect the presence and location of a touch within the display area. The touch screen 108 is used during the game play between start of a game and the end of a game. A game is considered to have started once a wager is placed and considered complete once the wager has been lost or won. Certain functions of the pushbutton are: initiation of game play, credit output, gameplay selection, completion of gameplay etc. A midtrim 112 of the machine 100 houses the pushbuttons 106.

The tactile input may optionally or further include a joystick comprising of a stick that pivots on a base and reports its angle or direction to the device it is controlling. The tactile input may optionally or further include a trackpad/touchpad being a pointing device featuring a tactile sensor to translate the motion and position of a user's fingers to a relative position on screen.

It should be appreciated that tactile input may include any suitable device that enables the player to produce an input signal that is received by the processor. Tactile input in the form of pushbuttons 106 and/or regions on touch screen 108 may include a one bet button, a max bet button, or a repeat the bet button. With a one bet button for instance, the player places a bet by pushing the one bet button. The player may increase the bet by one credit each time the player pushes the bet one button.

The midtrim 112 also houses credit input device including a bill collector 114. The credit input device may further include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A credit dispenser in the form of a coin tray 116 is mounted beneath the console 102 and is provided for cash payouts from the machine 100 to the player. A hopper device (not shown) is provided which dispenses coins, or tokens equal to the amount of credit currently on the machine, into the coin tray 116. Aside from the coin tray 116, the credit dispenser may also include a ticket dispenser for issuing a ticket dispensed by a printer which the user can redeem for cash, a note dispenser, a near field communications transmitter or means to enable remote credit transfer. It should be appreciated that any suitable payout mechanisms, such as funding to the player's electronically recordable identification card or smart card, may be implemented in accordance with the gaming machine disclosed herein.

The gaming machine 100 includes a top box 118 on which artwork 120 is carried in the form of electronic visual display units. The artwork 120 could also be made from physical materials such as paper, plastic banners or posters. The artwork 120 may have generic information related to the machine or gaming system or the artwork 120 be specifically made for a particular game to be played on the machine 100. Whilst the artwork 120 is shown as being carried on the top box 118 the art work 120 can also be positioned in or on the bottom panel of the door 105, or any other part of the gaming machine 100 visible to the player.

The gaming machine 100 further includes an auditory unit in the form of speakers (not shown) to provide auditory feedback to the player of the gaming machine 100.

Referring to FIG. 2 of the drawings, game logic circuitry 200 is illustrated. The game logic circuitry 200 includes a gaming controller 201 (otherwise referred to as a logic cage) designated by the dashed lines. As will be appreciated by those skilled in the gaming industry, the logic cage 201 includes a box-like mechanical structure that has slots to guide logic cards into the proper location for electronically plugging into a backplane mounted at the rear of the cage structure. The backplane has connectors for accepting mating connectors on the logic cards. The logic cage and associated cards form one of the basic components of the gaming machine 100 and is securely housed within the cabinet of the gaming machine 100.

Central to the logic cage is a central processing unit 202 such as a processor, a microcontroller-based platform, a suitable integrated circuit, or one or more application-specific integrated circuits (ASIC's). The processor 202 is in communication with or operable to access or to exchange signals with at an outcome evaluator 203, RAM 204, ROM 206, a non-volatile memory in the form of a compact flash 230, an audio output 208 via an audio control module 209, and a random number generator 210. The audio control module 209 has its own digital signal processor, analogue to digital converters, amplifiers and other circuitry necessary to broadcast the output from the speakers. RAM 204 may include non-volatile RAM (NVRAM), magnetic RAM (MRAM), ferroelectric RAM (FeRAM), and other forms as commonly understood in the gaming industry.

Compact flash memory 230 is physically secured within a slot in the logic cage 201. In one embodiment, the compact flash memory 230 is physically secured inside the logic cage within game logic circuitry 200 by a mechanical locking mechanism. Compact flash memory 230 is partitioned 231 into two parts. A first part comprises a game software module 232 and a second part comprises a metering information module 234.

The processor 202 runs executable code residing in game software module 232 of compact flash 230 that facilitates play of the game by a player through the display device and/or push buttons and touch sensors mounted in the screen of the display. Metering information module 234 contains the gaming machine parameters which include values that would usually be stored on a hard meter. The values in metering information module 234 are only ever incremented, and cannot be reset or decremented. The only way to alter the values stored is by running the executable code stored in game software module 232, which is executed by processor 202. The executable code further interacts with the credit dispenser 116 via a payout mechanism 224 and the auditory output 208. The game software module 232 contains the rules of the game, the sequence of gameplay, communicates with external systems, monitors peripheral equipment, maintain integrity of the software code, etc. The processor 202 continually checks for error conditions.

A program which implements the game logic circuitry 200 and the user interface is further run by the central processing unit 202. The processor 202 forms part of a controller 216 that drives the screen of the video display unit 104 and that receives input signals from sensors 218. The sensors 218 include sensors associated with the push buttons and touch sensors mounted in the screen of the video display unit 104. The controller 214 also receives input pulses from mechanisms 220 and 224 to determine whether or not a player has provided sufficient credit from either payment device 114 or payment device 116 to commence playing.

In one embodiment, a player may insert an identification card into a card reader (not shown) of the gaming machine 100. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

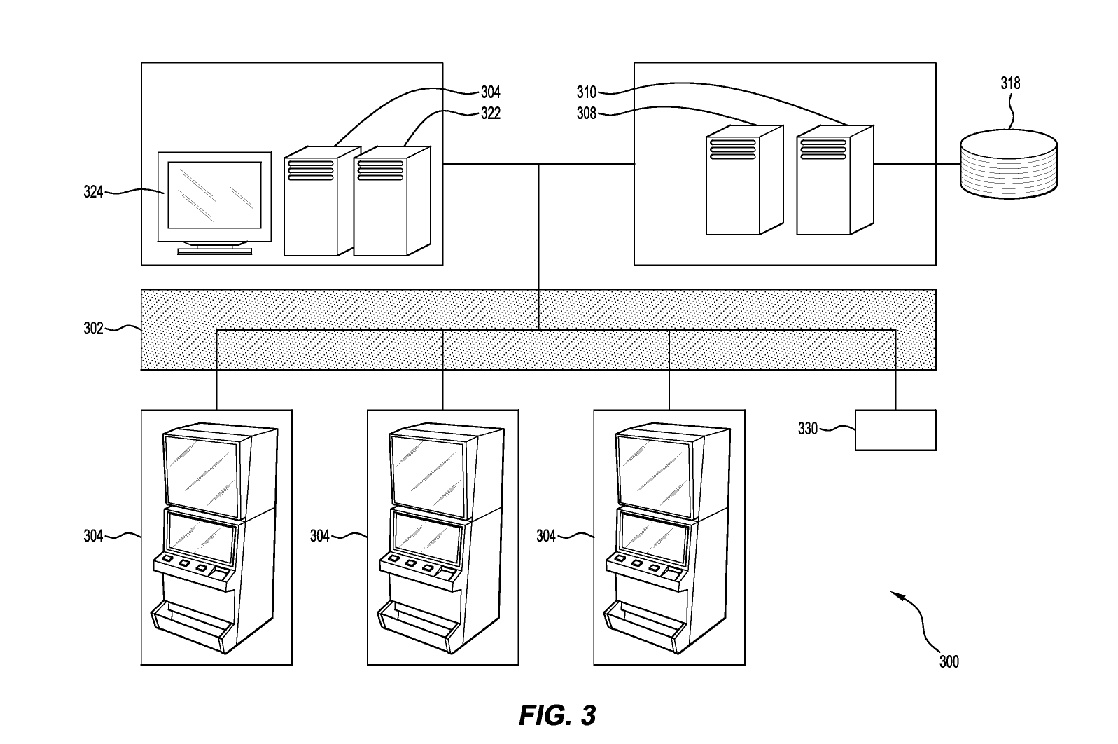

FIG. 3 shows a gaming system 300 in accordance with an alternative embodiment. The gaming system 300 includes a network 302, which for example may be an Ethernet network. The network 302 may also comprise a wide area network (“WAN”), the plain-old-telephone-system (“POTS), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random generator engine. Alternatively, a separate random number generator server could be provided. Further, persons skilled in the art will appreciate that a plurality of game servers could be provided to run different games or a single game server may run a plurality of different games as required by the terminals.

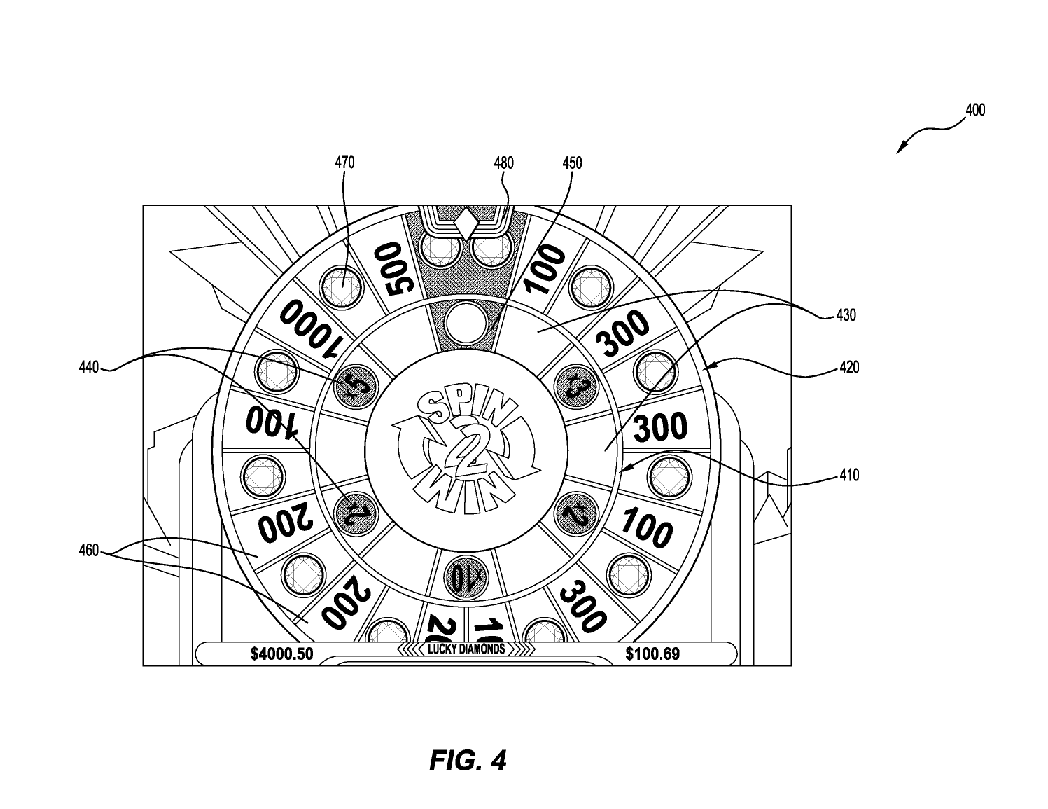

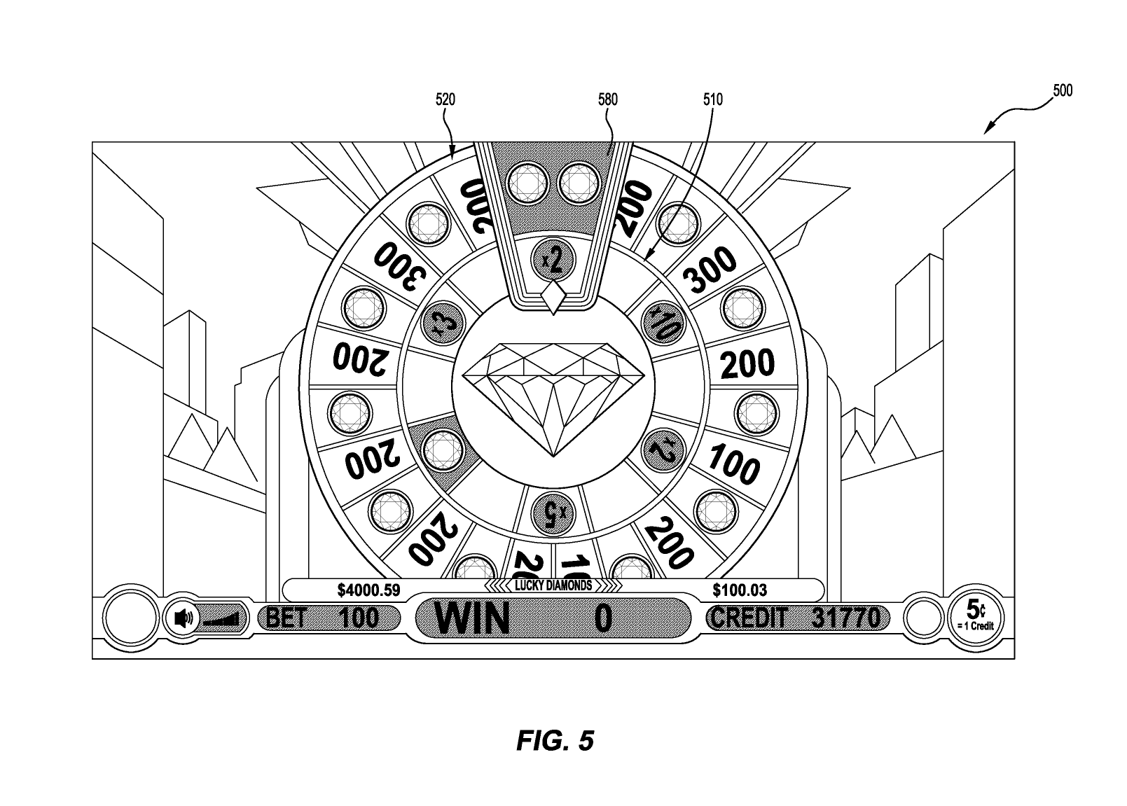

Referring now to FIGS. 4 and 5, features and functions of game machine 100 and gaming system 300 are described in further detail with respect to display images 400 and 500 generated by execution of code comprised in the game software module 232. FIG. 4 shows an example gaming machine display illustrating the presentation screen of the bonus game before actual play of the bonus game commences. FIG. 5 shows an example gaming machine display illustrating the wheel spin outcome area which has resulted from the bonus game having been played.

The bonus game is initiated after play of a primary game. The player may be prompted to respond to a request as to whether they wish to immediately play the bonus game or whether they wish to play the game at a later point in time. The player deciding to immediately commence play touches an area of the display screen 104 to commence play.

Referring to FIG. 4, initiation of the game causes the display of the bonus game 400. The bonus game consists of a first inner wheel 410 and a second concentric outer wheel 420. The inner wheel 410 is comprised of twelve substantially evenly spaced segments, six of which containing an indicia having no particular value 430, five containing a prize multiplier 440 and one containing a special symbol in the form of a diamond 450. The outer wheel has twenty four substantially evenly spaced segments, twelve having bonus prize indicia with a particular value 460 and twelve having a special symbol in the form of a diamond 470.

Also shown is a result designator 480 which points to one segment from the first inner wheel 410 and two segments from the second outer wheel 420. The initiation presentation 400 shows the combination required to win a major jackpot, namely three diamonds within the result designator 480.

To initiate spinning of the wheels the player uses a swipe gesture. In other embodiments the player can press a button or still further the player can touch the centre of the wheel labelled “spin to win”. Initially the wheel segment selector is absent from the display.

The wheel segment selector sector appears shortly after the wheels commence spinning.

Referring now to FIG. 5, the gaming machine display illustrating the wheel spin outcome area which has resulted from the bonus game having been played is illustrated.

Control of electronic wheels 510, 520 on display 104 are provided in part by random number generator 210. RNGs are well-known in the art, and any type of RNG may be implemented for the standard mode of play and/or the bonus mode of play in accordance with the described embodiment of the invention. Additionally they may be implemented using hardware, software operable in connection with the processor 202, or some combination of hardware and software. In accordance with generally known technology in the field of gaming machines/slot machines, the processor 202 associated with the gaming machine 100, under appropriate program instruction, simulates the rotation of the plurality of wheels. The gaming controller 201 causes the wheels 510, 520 to have the appearance of spinning in the appropriate directions, wheel 510 in a clockwise direction and wheel 520 in an anticlockwise direction. Accordingly, the wheels 510, 520 will then either slowly stop spinning, or may even abruptly stop spinning in some embodiments.

When the wheels 510, 520 stop spinning, a symbol from the first wheel 510, and a pair of symbols from the second wheel 520 are visible by way of the result designator 580. The gaming controller 201 is arranged so that the result designator 580 includes a mechanism that sets the segments within the boundary of the result designator 580 apart from the neighbouring segments.

Each presentation of the result designator 580 is stored in the memory of the gaming machine 100 or 304 (either RAM 204 or Flash 230) for use by the processor 202 (executing the code of software module 232) to determine, in cooperation with the outcome evaluator 203, whether outcome corresponds with a winning outcome.

Once the set of symbols 506 from the result designator 580 is determined by execution of the game software module 232 in cooperation with the random number generator 210, the game software module 232 in cooperation with the outcome evaluator 203 determines whether the symbols comprise a winning combination.

Whilst the player in this embodiment did not win the major jackpot, the combination of indicia in the result designator 580 presents two diamonds and a 2× multiplier. Two diamonds results in a win of the minor jackpot and the presence of the multiplier in the wheel segment selector means that the player is awarded 2× the minor jackpot. In an embodiment where the combination of indicia in the wheel segment selector presented two diamonds and a bonus prize of “300” the player would be awarded the minor jackpot and a bonus prize of 300 credits. In an embodiment where the combination of indicia in the wheel segment selector presented one diamond, a bonus prize of “200” and a ×5 multiplier the player would be awarded 1000 credits.

It should be appreciated that whilst the invention described above has been implemented electronically via display presentations, the invention may be implemented via a mechanical presentation using physical wheels. Furthermore in the description above, the gaming activity includes a pair of concentric wheels (or rings). However any number of wheels over and above 2 wheels may be used, depending on the particular application.

An advantage of the described embodiment is that it allows for an exciting wheel spinning feature that produces outcomes with a single spin.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While the foregoing description has been provided by way of example of the preferred embodiments of the present invention as presently contemplated, which utilise gaming machines of the type found in casinos, those skilled in the relevant arts will appreciate that embodiments of the present invention also may have application to internet gaming and/or have application to gaming over a telecommunications network, where mobile handsets are used to display game outcomes and receive player inputs. Such mobile devices include smart phones, notebooks, tablets, iPads and laptop computers. For instance free mobile device games may be offered for download and play on a players personal mobile device as a bonus game play. In such an embodiment the gaming machine may comprise a power interface to enable interaction between the respective devices and/or a communication or wireless interface to enable data transfer. During game play, the gaming machine may be configured to send information to the player's personal mobile device.

Further embodiments may enable a player to upload the outcome of a game or bonus game to a social media site(s), post tournament scores etc.

Certain steps in the processes or process flows described in this disclosure naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention.

1. A gaming machine is provided comprising:
a display to display images;
a user interface to receive input from a player;
a memory;
a game controller configured to access the memory, control display of the images and process input received via the user interface, the game controller further configured to:
control generation and display of a game of chance comprising a first inner wheel and at least a second concentric wheel; each of the first inner wheel and the at least second concentric wheel comprising a plurality of segments having associated indicia, wherein the first inner wheel has fewer segments than the at least second concentric wheel or a subsequent concentric wheel; and
random selection means including means for initiating simultaneous and independent rotation of each wheel;
wherein, the game controller is further configured to control cessation of rotation of each of the wheels, to identify at least one first segment from the first inner wheel and at least one segment from the second or a subsequent concentric wheel to determine if the combination of the identified segments comprises a winning combination.

2. A gaming machine according to claim 1, wherein the game controller is configured to control generation and display a game of chance comprising a first inner wheel and a second outer wheel wherein the first inner wheel has n segments and the second outer wheel has 2×n segments.

3. A gaming machine according to claim 1, wherein the game controller is configured to control generation and display a game of chance comprising a first inner wheel having n segments, a second wheel having 2×n segments and a third outer wheel having 4×n segments.

4. A gaming machine according to claim 1, wherein the game controller is configured to control generation and display a game of chance comprising four or more wheels, wherein the number of segments for each successive wheel is (2^{m-1}×n) where m is the wheel number.

5. A gaming machine according to claim 1, wherein the game controller is further configured to control generation and display of a wheel segment selector which points to 2^{m-1} segments from each wheel when the wheels are stationary, where m is the wheel number.

6. A gaming machine according to claim 5, wherein the game controller is further configured such that if the combination of indicia from the segments which the segment selector points to equals a winning combination, the gaming machine is arranged to indicate an award to the player.

7. A gaming machine according to claim 1, wherein at least certain of the indicia on the first inner wheel and the second wheel comprise special symbols.

8. A gaming machine according to claim 7, wherein a further certain number of the indicia on the first inner wheel comprise prize multipliers and a further certain number of the indicia on the second wheel comprise bonus prizes.

9. A gaming machine according to claim 1, wherein the game of chance is a primary gaming activity.

10. A gaming machine according to claim 1, wherein the game of chance is a bonus feature game.

11. A gaming machine according to claim 1, wherein the plurality of indicia are positioned on the peripherals of the viewable surface face of each wheel such that all indicia on each wheel are viewable to the user.

12. A gaming machine according to claim 1, wherein each of the wheels spin in the same direction.

13. A gaming machine according to claim 1, wherein at least one of the wheels spins in an opposite direction to the direction of the other wheels.

14. A method of game play executed by a computerised game controller, the method comprising:
controlling generation and display of a game of chance comprising a first inner wheel and at least a second concentric wheel; each of the first inner wheel and the at least second concentric wheel comprising a plurality of segments having associated indicia, wherein the first inner wheel has fewer segments that the at least second concentric wheel or a subsequent concentric wheel;
initiating simultaneous and independent rotation of each wheel;
controlling cessation of rotation of each of the wheels and to register an outcome;
identifying at least one first segment from the first inner wheel and identifying at least one segment from the second or a subsequent wheel; and
determining if the combination of the identified segments comprises a winning combination.

15. A method of game play executed by a computerised game controller according to claim 14, wherein the game controller is configured to control generation and display a game of chance comprising a first inner wheel and a second outer wheel wherein the first inner wheel has n segments and the second outer wheel has 2×n segments.

16. A method of game play executed by a computerised game controller according to claim 14, wherein the game controller is configured to control generation and display a game of chance comprising a first inner wheel having n segments, a second wheel having 2×n segments and a third outer wheel having 4×n segments.

17. A gaming system comprising at least one server and at least one client device, wherein the at least one server and at least one client device are configured to cooperate with each other to execute program instructions to:
control generation and display of a game of chance comprising a first inner wheel and at least a second concentric wheel; each of the first inner wheel and the at least second concentric wheel comprising a plurality of segments having associated indicia, wherein the first inner wheel has fewer segments that the at least second concentric wheel or a subsequent concentric wheel;
initiate simultaneous and independent rotation of each wheel;
control cessation of rotation of each of the wheels and to register an outcome;
identify at least one first segment from the first inner wheel and identifying at least one segment from the second or a subsequent wheel; and
determine if the combination of the identified segments comprises a winning combination.

18. Computer-readable storage storing executable program code that, when executed by a game controller configured to control generation and display of a game of chance comprising a first inner wheel and at least a second concentric wheel, each of the first inner wheel and the at least second concentric wheel comprising a plurality of segments having associated indicia, and where the first inner wheel has fewer segments than the at least second concentric wheel or a subsequent concentric wheel, causes the game controller to:
initiating simultaneous and independent rotation of each wheel;
controlling cessation of rotation of each of the wheels and to register an outcome; and
identifying at least one first segment from the first inner wheel and identifying at least one segment from the second or a subsequent wheel; and
determining if the combination of the identified segments comprises a winning combination.

19. Computer-readable storage according to claim 18, wherein the game controller is configured to control generation and display a game of chance comprising a first inner wheel and a second outer wheel wherein the first inner wheel has n segments and the second outer wheel has 2×n segments.

20. Computer-readable storage according to claim 18, wherein the game controller is configured to control generation and display a game of chance comprising a first inner wheel having n segments, a second wheel having 2×n segments and a third outer wheel having 4×n segments.

21. Computer-readable storage according to claim 18, wherein the game controller is configured to spin one or more of the wheels in a first direction and the remaining wheels in an opposite direction.
